(19) United States
(12) Patent Application Publication
(10) Pub. No.: US 2025/0245430 A1
(43) Pub. Date: Jul. 31, 2025

(54) EFFICIENT SPECULATIVE DECODING IN AUTOREGRESSIVE GENERATIVE ARTIFICIAL INTELLIGENCE MODELS

(71) Applicant: QUALCOMM Incorporated, San Diego, CA (US)

(72) Inventors: Wonseok JEON, San Diego, CA (US); Mukul GAGRANI, Milpitas, CA (US); Mingu LEE, San Diego, CA (US); Raghavv GOEL, San Diego, CA (US); Junyoung PARK, Palo Alto, CA (US); Christopher LOTT, San Diego, CA (US)

(21) Appl. No.: 18/424,375

(22) Filed: Jan. 26, 2024

(51) Int. Cl. G06F 40/284; G06F 16/901

(52) U.S. Cl. CPC G06F 40/284; G06F 16/9027

(57) ABSTRACT

Certain aspects of the present disclosure provide techniques and apparatus for efficiently generating a response to a query input in a generative artificial intelligence model. An example method generally includes generating, based on an input prompt and using a first machine learning model, a set of tokens including one or more subsets of tokens. Each respective subset of the one or more subsets corresponds to a respective portion of a response to the input prompt and includes a fixed number of tokens corresponding to a beam width for a beam search through the set of tokens. The set of tokens is output to a second machine learning model for verification, and information identifying a selected sequence of tokens from the generated set of tokens is received from the second machine learning model. The selected sequence of tokens is output as the response to the input prompt.

### INTRODUCTION

Aspects of the present disclosure relate to generative artificial intelligence models, and more specifically to speculative decoding in generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image from an input text description of the content of the desired image, decision transformers, in which future actions are predicted based on sequences of prior actions within a given environment, or the like.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., a word or part of a word) generated as part of the response. The output of each pass may be a probability distribution on a set of tokens (e.g., words or parts of words) from which the next token (e.g., a word or part of a word) may be selected, for example, by sampling or based on maximum likelihood. Because a pass through a large language model is used to generate each word (or token(s)) in a response to a query, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a method for efficiently generating a response to an input prompt using a generative artificial intelligence model. The method generally includes generating, based on an input prompt and using a first machine learning model, a set of tokens including one or more subsets of tokens. Each respective subset of the one or more subsets corresponds to a respective portion of a response to the input prompt and includes a fixed number of tokens corresponding to a beam width for a beam search through the set of tokens. The set of tokens is output to a second machine learning model for verification, and information identifying a selected sequence of tokens from the generated set of tokens is received from the second machine learning model. The selected sequence of tokens is output as the response to the input prompt.

Certain aspects of the present disclosure provide a method for efficiently generating a response to an input prompt using a generative artificial intelligence model. The method generally includes receiving an input prompt and a set of tokens generated by a first machine learning model, the set of tokens including one or more subsets of tokens. Each respective subset of the one or more subsets corresponds to a respective portion of the response to the input prompt and includes a fixed number of tokens corresponding to a defined beam width for a beam search through the set of tokens. A probability distribution associated with each respective subset of tokens in the set of tokens is compared to a corresponding probability distribution generated by a second machine learning model for the respective subset of tokens. Tokens are selected from the set of tokens based on the comparing, and an indication of the selected tokens is output to the first machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example of speculative decoding in generative artificial intelligence models, according to aspects of the present disclosure.

FIGS. 2A and 2B illustrate examples of recursive speculative decoding in generative artificial intelligence models, according to aspects of the present disclosure.

FIG. 3 illustrates an example of recursive speculative decoding in generative artificial intelligence models using a constant beam width for a beam search through a set of speculatively generated tokens, according to aspects of the present disclosure.

FIG. 4 illustrates a tree of tokens generated using recursive speculative decoding and a constant beam width for a beam search through a set of speculatively generated tokens, according to aspects of the present disclosure.

FIG. 5 illustrates an example of recursive speculative decoding in generative artificial intelligence models using a constant beam width for a beam search through a set of speculatively generated tokens and an attention map representing a set of speculatively decoded tokens, according to aspects of the present disclosure.

FIG. 6 illustrates example operations for generating a response to an input prompt using a generative artificial intelligence model and efficient recursive speculative decoding, according to aspects of the present disclosure.

FIG. 7 illustrates example operations for verifying a response to an input prompt using a generative artificial intelligence model and efficient recursive speculative decoding, according to aspects of the present disclosure.

FIG. 8 depicts an example processing system configured to perform various aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input queries using generative artificial intelligence models.

Generally, generative artificial intelligence models generate a response to a query input into the model. For example, a large language model (LLM) deployed within a chatbot can generate a response to a query using multiple passes through the large language model, with each successive pass being based on the query (which may be tokenized for processing) and the tokens (or words) generated using previous passes through the large language model. Generally, these large language models may include a large number (e.g., billions, or even trillions) of weights or parameters within the model. Because of the size of these models and the operations performed on each token to predict what should be the next token generated in response to a query and the previously generated tokens, it may not be practical, or even possible, to deploy large language models on a variety of devices which have limited memory, storage, and/or processing capabilities relative to cloud compute instances on which large language models typically operate. Further, in some cases, the memory bandwidth involved in generating a response to a query provided as input into a model may prevent compute resources from being used for other tasks.

To improve the efficiency and throughput of large language models, speculative decoding techniques allow for a smaller language model, sometimes known as a draft large language model (or as a draft model or an approximation model), to execute (e.g., sequentially or in parallel) with a larger language model, sometimes known as a target large language model (or as a target model). In such a case, the draft model can generate speculatively additional tokens in sequence and probabilities used for sampling these additional tokens based on a current set of accepted tokens. The target model can generate tokens based on the tokens generated by the draft model. To generate a result, the target model can perform rejection sampling on a per-token basis to accept or reject individual tokens generated by the draft model such that the draft model and the target model have similar probability distributions.

In some aspects, the draft model may be a pruned version of the target model chosen such that the draft model and target model have similar probability distributions. In other aspects, the draft model may be a smaller version of the target model (e.g., trained on millions of tokens, instead of hundreds of millions or even billions of tokens).

Certain aspects of the present disclosure provide techniques and apparatus for generating responses to a query input into a generative artificial intelligence model (e.g., a large language model) using recursive speculative decoding techniques and a constant number of tokens corresponding to a beam width for a beam search through a speculatively decoded set of tokens for each subset of tokens generated using the generative artificial intelligence model. Generally, the draft model can generate one or more sets of tokens as candidate responses to the query, which may be structured as a plurality of branches (e.g., in a tree data structure). Each of the one or more sets of tokens may have a constant width, and tokens for which no tokens in a speculatively generated set of children tokens meets an acceptance criteria may not be associated with tokens in a subsequent set of tokens. The target model, in turn, can perform sampling rejection recursively on tokens provided by the draft model. Generally recursive sampling rejection allows for the probability distribution used by the target model in sampling tokens generated by the draft model to be updated to remove a token rejected by the target model, and the updated probability distribution is then used to sample subsequent tokens generated by the draft model. By generating a response to a query input into a generative artificial intelligence model using recursive speculative decoding techniques and a constant number of tokens for each subset of tokens generated by the generative artificial intelligence model, aspects of the present disclosure may retain a close relationship between the probability distributions within the draft and target models. Further, doing so may increase the throughput of the draft and target models (e.g., the number of tokens generated per second) relative to draft and target models configured to generate responses on a per-token basis and may minimize, or at least reduce, the computational overhead involved in generating and verifying a speculatively generated response to the query.

### Speculative Decoding in Generative Artificial Intelligence Models

Generally, autoregressive token generation (e.g., in large language models) may take historical tokens as an input in order to generate an output. That is, autoregressive token generation may be represented by the expression:

$${x}_{t} \sim p ( x \vert {x}_{0} , {x}_{1} , … , {x}_{t - 1} ) \to {x}_{t + 1} \sim p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on the selection of tokens x₀ through xₜ. Generally, a single token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates tokens faster than the target model, with the target model being used to verify the tokens (speculatively) generated by the draft model.

In a speculative decoding pipeline, the draft model may speculatively generate n tokens autoregressively, according to the expression:

$${x}_{t + 1}^{draft} \sim {p}_{t}^{draft} = {p}^{draft} ( x \vert {x}_{0} , … , {x}_{t} ) , {x}_{t + 2}^{draft} \sim {p}_{t + 1}^{draft} , … , {x}_{t + n}^{draft} \sim {p}_{t + n - 1}^{draft}$$

where t corresponds to a point in time, pₜ^{draft} corresponds to the conditional probability distribution associated with a selected token x at time t conditioned on the selection of tokens x₀ through xₜ₋₁, and xₜ^{draft} represents a token x speculatively generated at time t by the draft model.

The target model takes the generated n tokens and processes the n tokens in parallel to generate probability distributions for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

where k corresponds to a token index relative to the generated n tokens and pₜ^{target} corresponds to a probability distribution generated by the target model at time t for the tokens x generated by the draft model.

The target model can then verify the tokens generated by the draft model by comparing distributions from the draft model and target model to determine whether a token is accepted or rejected. A given token xₜ₊ₖ^{draft} may be accepted when ƒ(pₖ^{draft}, pₖ^{target})<α, for some function ƒ and some threshold a (also known as an acceptance rate). Otherwise, the token may be rejected. The final token may then be generated at the first rejection position or at the last position n based on some function g(pₖ^{graft}, pₖ^{target}).

Speculative decoding, with an acceptance rate of a, may result in cost reductions relative to using a single autoregressive model to generate tokens iteratively. Inference cost savings, relative to iterative token generation, may be represented by the expression:

$${C}^{AR} = {NC}^{target} \to {C}^{SD} = {nNC}^{draft} + \frac{N}{α + 1} {C}^{target}$$

where N corresponds to a number of tokens, C^{AR} corresponds to a computational cost using an acceptance rate of a, C_{target} corresponds to a computational cost of generating a set of tokens using the target model, C^{draft} corresponds to a computational cost of generating a set of tokens using the draft model, C^{SD} corresponds to a computational cost of speculatively generating a set of tokens using the draft model, and n corresponds to a number of tokens generated speculatively in a single pass through an autoregressive model. Consider an example in which N=1000, C^{target}=10, C^{draft}=1, n=4, and α=3. In such an example, speculative decoding may result in a 35% reduction in computational expense relative to autoregressive iterative token generation alone.

However, speculative decoding on a per-token basis, as discussed, may impose limits on the rate at which tokens are generated, as a first token may be sampled individually by a draft model and then verified by a target model before the next token is sampled by the draft model and verified by the target model. That is, generating a response to an input prompt using per-token speculative decoding techniques may involve executing the draft model and target model for each token generated as part of a response to the input prompt, which may use significant amounts of computational resources (e.g., processor time, memory, memory bandwidth, etc.) in order to generate the response.

### Example Recursive Speculative Decoding in Generative Artificial Intelligence Models

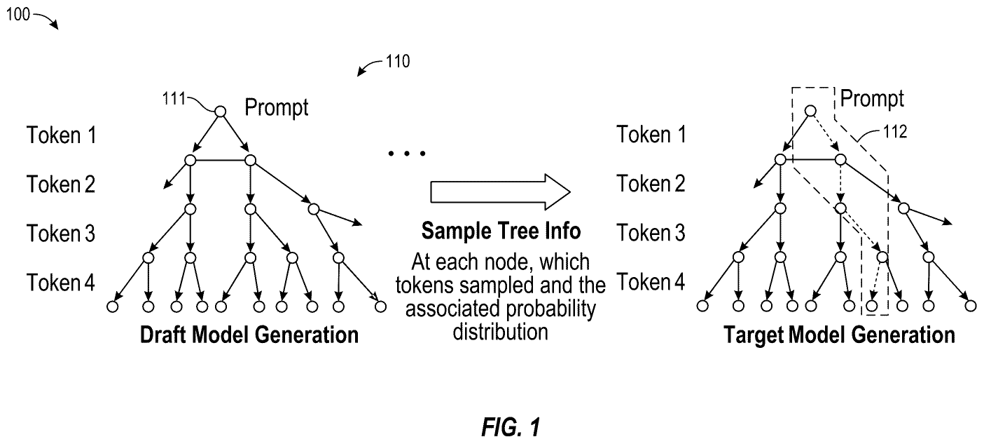

FIG. 1 illustrates an example 100 of recursive speculative decoding in generative artificial intelligence models, according to aspects of the present disclosure.

As illustrated, a draft model and a target model can be used in conjunction (or otherwise together) to perform recursive speculative decoding of tokens to generate a response to a query received for processing by one or more generative artificial intelligence models. As discussed in further detail below, recursive speculative decoding of tokens may allow for multiple sets of tokens (or sequences of tokens) to be speculatively generated by a draft model for verification by a target model. Because multiple sets (or sequences) of tokens may be generated by a draft model for verification by a target model, recursive speculative decoding may increase the token generation rate of generative artificial intelligence models by generating multiple sets (sequences) of tokens that can be accepted as a correct response, as larger numbers of sets of tokens may increase the probability that at least one set includes a sequence of one or more tokens that will be accepted as a response.

The draft model generally selects a plurality of high probability nodes (tokens) from a probability distribution for an output over a set of potential tokens, given an input of the received query. The high probability nodes (tokens) may be selected based on various techniques, such as top-k selection (e.g., selection of the k tokens having the highest probabilities within a probability distribution), nucleus-based selection (e.g., selection based on a sum of probabilities meeting a threshold probability), or the like. By choosing many candidate tokens, the draft model can sample tokens based on the probability distribution and organize a tree structure that may be recursively traversed, as discussed in further detail below, in order to identify a set of tokens that are a suitable output for the given input.

When a sampled group of tokens is input into the draft model in the next iteration of executing the draft model, the tokens in the sampled group of tokens are input at the sample location and treated independently. The result may be a tree data structure 110, with a prompt as a root node 111 of the tree data structure, and subsequent levels within the tree data structure 110 representing different tokens (or groups of tokens), combined with each of the previously selected token combinations. At some point in time (e.g., after generating a tree with a defined depth, corresponding to a maximum length of a sequence generated by the draft model), the draft model may output the generated tree data structure 110 to the target model for further processing. The tree data structure 110 may, in some aspects, be output to the target model with groupings and selection probabilities generated by the draft model.

In some aspects, the draft model may be configured to trigger generation of tokens by the target model (and subsequent speculative decoding) based on various criteria. These criteria may include a complexity criterion or performance criterion, such as a complexity or performance criterion associated with the size of the generated tree data structure 110. In some aspects, these criteria may include a time criterion associated with an expected amount of time for the target model to generate a set of tokens against which the generated tree data structure 110 can be compared. Generally, these complexity and/or performance criteria may set an upper bound on the number of tokens generated by the draft model for verification by the target model. This upper bound may, in some aspects, be based on a number of nodes in the tree data structure and may be influenced, for example, by a branching factor defined for different levels of the tree data structure 110 into which sampled tokens are organized, a depth of the tree data structure 110, or the like. The worst-case computational load at the last round of speculative token generation may be configured to be bound by memory bandwidth at the device on which the draft model executes.

In some aspects, the number of nodes at each level of the tree data structure 110 (e.g., where token n illustrated in FIG. 1 corresponds to the n^{th} level in the tree data structure 110, and where level 0 corresponds to the root node 111 in the tree data structure 110) and the depth of the tree data structure 110 may be defined a priori. The number of nodes at each level of the tree may be defined globally, on a per-level basis, or in some other manner. For instance, the number of nodes at any level of the tree data structure 110 may be defined based on a branching factor at the immediate prior level of the tree data structure 110. For example, a branching factor of 2 for nodes at the n^{th} level of the tree data structure 110 may result in the generation of 2 nodes (tokens) at the n+1^{th} level of the tree data structure 110 for each node (token) at the n^{th} level of the tree. Meanwhile, the depth of the tree data structure 110 may be defined based on a maximum number of tokens (e.g., words) that can be generated using any pass through the draft model. For example, if the draft model is configured to generate a sequence with a maximum length of 5 tokens during any instance of speculative generation, then the depth of the tree may be 6 (to include, at the first level of the tree data structure 110, the root node 111 corresponding to the input into the draft model).

The target model recursively performs rejection sampling on (1) the tokens generated by the draft model and included in the generated tree data structure 110 and (2) a probability distribution q provided as input to the target model. Rejection sampling may be performed recursively at each node in the generated tree, where a terminating condition of token selection by the target model at a given layer of the tree data structure 110 is modeled as a recursion problem in which a terminating condition of the recursion problem is either acceptance of a token or rejection of all tokens. In recursively performing rejection sampling, the target model can accept or reject a token and adjust the probability distribution used to verify a subsequent token in the generated tree. If a token is rejected, an updated probability distribution q′=(q−p) may be generated for use in evaluating subsequent tokens in the tree, where p represents the probability associated with the rejected token from the original probability distribution q. Subsequently, the updated probability distribution q′ may be used to evaluate the next token in the tree. The resulting selected set of tokens 112 may be identified recursively, by traversing from the root node 111 of the generated tree data structure 110 based on the updated probability distributions generated for each node in the generated tree data structure, as discussed in further detail below.

In some examples, recursive rejection sampling may be performed using “greedy” techniques, in which the first token that is accepted is returned as a valid portion of a response to the input query (or prompt). In other examples, recursive rejection sampling may be performed to determine whether to accept each token at a given level in the tree data structure 110. The selected token at that given level in the tree data structure 110 may be, for example, the token having the highest probability of being a valid token for inclusion in a response to the input prompt. In still other examples, a cumulative probability distribution may be generated for each accepted sequence of tokens from the generated tree data structure, and the sequence with the largest cumulative probability distribution may be selected as the response to the input prompt. It should be recognized, of course, that these are but examples of techniques based on which sequences of tokens may be selected from the tree data structure 110, and other techniques for selecting sequences of tokens based on recursive rejection sampling (and corresponding adjustment of the probability distribution q when tokens are rejected) may be contemplated.

In some aspects, the draft model may match the probability distribution of the target model but may have faster inference performance than the target model on the same hardware. Generally, smaller models can generate many speculative tokens, but may have an increased likelihood of generated tokens being rejected by the target model. The speculative decoding techniques discussed herein may address this increased likelihood of token rejection, at the expense of increasing computational expense for longer sequences. Finally, at the draft model, a temperature parameter (generally used herein to refer to a parameter influencing the likelihood of the draft model selecting a token (word) with a lower likelihood) may be tuned to improve the performance of recursive speculative decoding. In some aspects, the draft model may be fine-tuned to match, or at least approximate, the probability distribution of the target model and maximize, or at least increase, the probability that speculatively generated tokens (or sequences of tokens) generated by the draft model will be accepted as valid tokens by the target model.

Generally, token generation performance for recursive speculative decoding may be increased relative to speculative decoding on a per-token basis. That is, for any given Kullback-Leibler (KL) divergence between the draft model and target model, the number of tokens generated for each target model run may be larger for recursive speculative decoding than for per-token speculative decoding. The KL divergence generally measures how the probability distribution of the draft model differs from the probability distribution of the target model (treating the target model as the reference distribution). Different selection strategies (e.g., group size, additional tokens, etc.) may have different computational complexity characteristics. Accordingly, the selection of a strategy for selecting tokens for acceptance of rejection using recursive speculative decoding may be based on a tradeoff between computational complexity and performance, given bounding parameters of read bandwidth for the draft and target models and hardware performance.

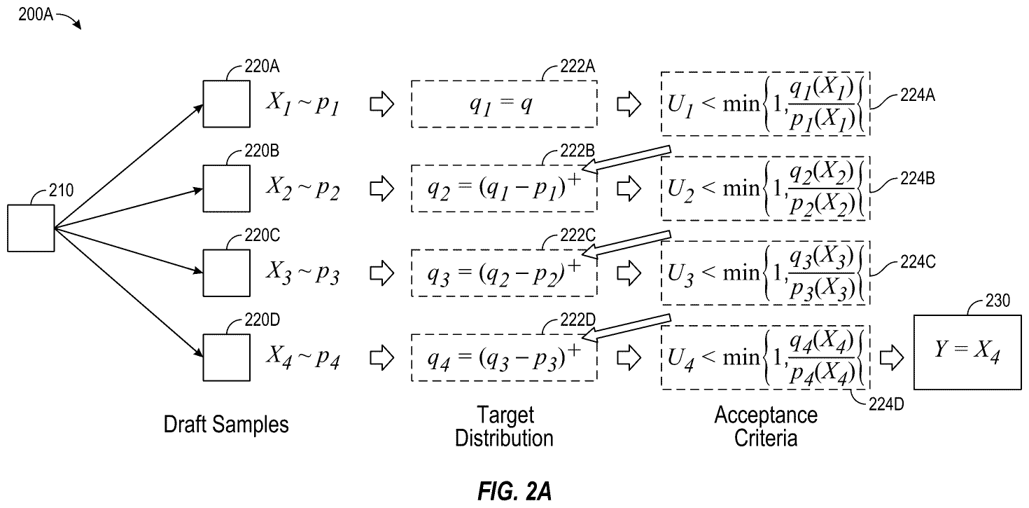

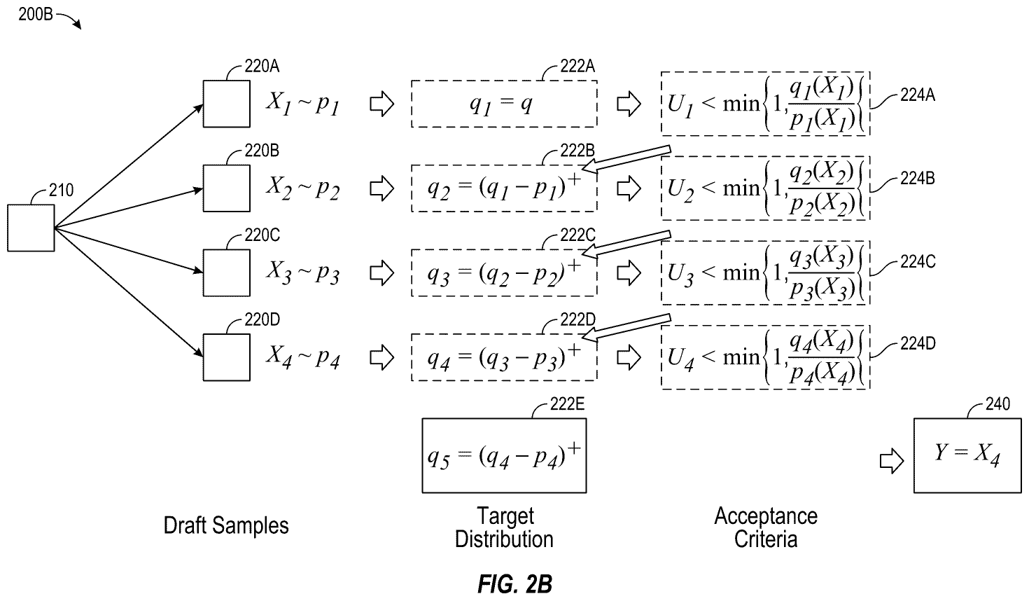

FIGS. 2A and 2B illustrate examples 200A and 200B (respectively) of recursive speculative decoding in generative artificial intelligence models, according to aspects of the present disclosure.

The example 200A illustrated in FIG. 2A depicts an example in which one of multiple tokens generated by a draft model is accepted for inclusion in a response to a prompt 210. As illustrated, the draft model generates four proposed tokens X₁ 220A, X₂ 220B, X₃ 220C, and X₄ 220D, with associated probabilities p₁, p₂, p₃, p₄ from an original target distribution q. A target model can sequentially examine these tokens to determine whether to accept or reject each token. As illustrated, the target model first examines token X₁ 220A to determine whether the token 220A should be accepted or rejected as a token to be returned as part of a response to a given input (e.g., the prompt 210). In this example, target distribution q₁ 222A may be set to the original target distribution q, and the target model can determine whether to accept or reject the token X₁ 220A based on selection criteria 224A:

$${U}_{1} < min \{ 1 , \frac{{q}_{1} ( {X}_{1} )}{{p}_{1} ( {X}_{1} )} \}$$

where U₁ represents a generated random number between [0, 1].

If the token X₁ 220A is accepted (not shown), then the token X₁ 220A may be output, and the target model analysis of the proposed tokens generated by the draft model may proceed to traverse the tree to analyze nodes (tokens) connected to the node represented by token X₁ 220A in the generated tree.

Otherwise, if, as illustrated, the token X₁ 220A is rejected, then the target model can proceed to determine whether the token X₂ 220B should be accepted or rejected. In doing so, the target model can use a new target distribution q₂ 222B, which may be the result of subtracting the probability p₁ associated with rejected token X₁ 220A from the target distribution q₁ 222A, such that q₂=(q₁−p₁)⁺. The target model can then determine whether to accept or reject the token X₂ 220B based on selection criteria 224B:

$${U}_{2} < min \{ 1 , \frac{{q}_{2} ( {X}_{2} )}{{p}_{2} ( {X}_{2} )} \}$$

where U₂ also represents a generated random number between [0, 1].

As with the token X₁ 220A discussed above, the target model can determine that the token X₂ 220B satisfies the acceptance criteria and thus return the token X₂ 220B as the selected token (not shown). Otherwise, if, as illustrated, the token X₂ 220B is rejected, then the target model proceeds to determine whether the token X₃ 220C should be accepted or rejected, using an updated target distribution q₃ 222C that removes p₂ from q₂ (e.g., such that q₃=(q₂−p₂)⁺) and acceptance criteria U₃ 224C. This process may continue until, as illustrated, it is determined that a token (in this example, the token X₄ 220D illustrated in the example 200A using an updated target distribution q₄ 222D) is accepted (e.g., based on acceptance criteria U₄ 224D) and output as the selected token Y 230.

The example 200B illustrated in FIG. 2B illustrates an example in which the target model rejects each of the tokens 220A-220D generated by the draft model. In the example 200B, the target model can generate a final target distribution q₅ 222E, sample a token from the final target distribution q₅ 222E, and terminate traversal of the generated tree. As illustrated, the final target distribution q₅ 222E may be the result of subtracting the probability associated with the final token in the set of generated tokens (e.g., the probability p₄ associated with the token X₄ 220D). The final target distribution q₅ 222E may be represented by the equation q₅=(q₄−p₄)⁺. A token 240 sampled from the final target distribution q₅ 222E may be returned as the output Y of performing recursive rejection sampling on the generated tokens.

Generally, the computational complexity involved in processing a set of speculatively decoded tokens such as that shown in the examples 200A and 200B scales with the length of a draft set of tokens generated by the draft model. For example, assuming a constant branching factor of n (that is, n tokens are speculatively generated for each token in a given subset of tokens), the computational complexity of the resulting set of speculatively decoded tokens for a draft length of L may be represented by the expression:

$$n + {n}^{2} + … + {n}^{L} = O ( {n}^{L} )$$

In other words, the size of the set of tokens generated by a draft model exponentially increases with the length of a draft set of tokens generated by the draft model. However, in generating a draft set of tokens using recursive speculative decoding techniques, the draft model may not consider probabilities associated with the generated tokens in determining whether to generate further tokens in a subsequent subset of tokens in the draft set of tokens. Thus, the resulting draft set of tokens may include a significant number of low-probability tokens for the target model to verify. These low-probability tokens may correspondingly have a high likelihood of rejection by the target model. As such, the inclusion of these low-probability tokens in the draft set of tokens may waste computing resources (e.g., processor time, memory, bandwidth, etc.) expended in the generation and verification of a response to an input query using a generative artificial intelligence model.

### Example Efficient Recursive Speculative Decoding Using a Constant Beam Width in Generative Artificial Intelligence Models

To reduce the computational expense involved in generating a response to an input query using recursive speculative decoding techniques, aspects of the present disclosure may allow for early truncation of sequences of tokens in a draft set of tokens based on probabilities associated with children tokens of each token in the draft set of tokens. Generally, the draft set of tokens may include a plurality of subsets of tokens, with each subset of tokens including the same number of tokens. Because each subset of tokens includes the same number of tokens, the growth rate of the set of tokens may be reduced relative to techniques in which tokens are speculatively generated for each token in a preceding subset of tokens, and the corresponding computational complexity may be reduced from O(n^{L}) to O(B×L), where B corresponds to the beam width (or otherwise the constant size of each subset of tokens) and L corresponds to the draft length. Further, because each subset of tokens includes the same number of tokens, aspects of the present disclosure may allow for early truncation of low-probability sequences of tokens. Thus, the size of a resulting draft set of tokens may be significantly smaller than the size of a draft set of tokens generated without early truncation of low-probability sequences of tokens.

In some examples, to search for an optimal response (or at least a suitable response) to an input query, a beam search technique can be used. A beam search is generally a breadth-first search that uses greedy techniques to reduce the number of tokens which are processed (e.g., verified) by a target model using the Gumbel top-k technique in which log probabilities for tokens are perturbed based on Gumbel random noise and the top k tokens are selected. In such a case, verification of the tokens speculatively generated by a draft model may start with the subset of tokens corresponding to the last token in a response (e.g., at level L of a tree representing a response with a draft length of L). That is, a token included in level n of a tree may be included in a set of tokens to be verified at level n if at least one token at level n+1 of the tree in the top set of tokens at level n+1 is a child of the token at level n. Meanwhile, a token included in level n of the tree may be excluded from the set of tokens to be verified at level n if no child tokens of the token at level n are included in the top set of tokens at level n+1.

While using a beam search of a set of tokens starting from the subset of tokens corresponding to the last token in the response may reduce the computational expense involved in verifying a response by eliminating tokens from the verification process, verification of a set of tokens may still be computationally expensive due to the number of sequence probabilities to be examined during the verification process. For example, in a model with seven billion parameters, a draft set of tokens may result in the verification of 32,000 children tokens. Further, the draft model may continue to generate a draft set of tokens without considering probabilities associated with the generated tokens in determining whether to generate further tokens in a subsequent subset of tokens in the draft set of tokens.

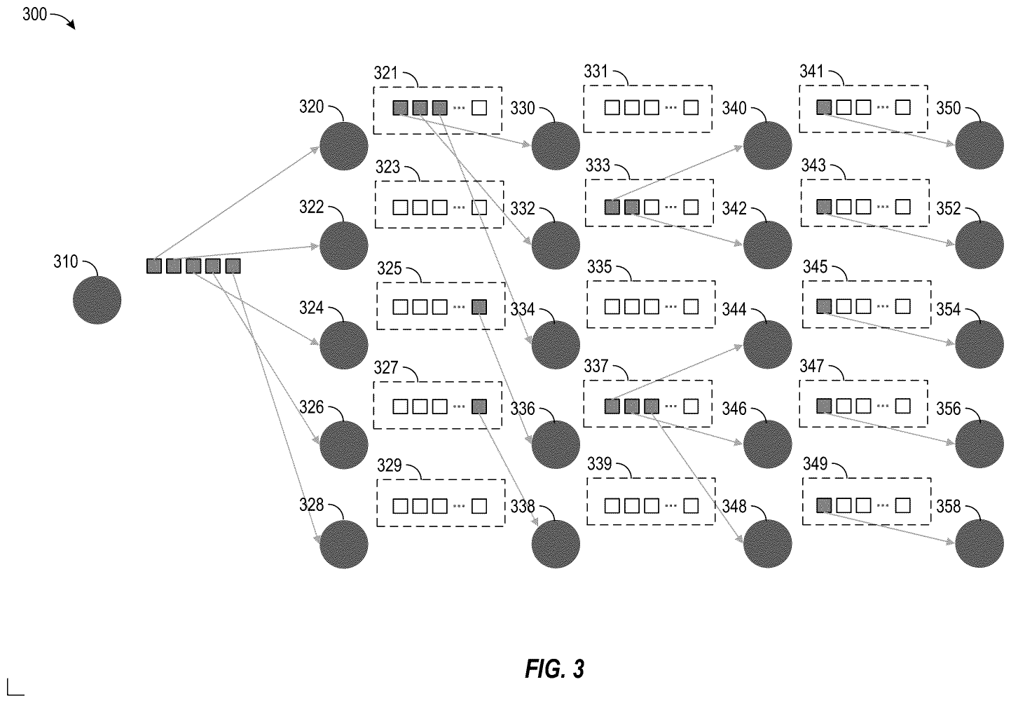

FIG. 3 illustrates an example 300 of recursive speculative decoding in generative artificial intelligence models using a constant beam width for a top-down beam search through a set of speculatively generated tokens, according to aspects of the present disclosure.

As illustrated in the example 300, an input prompt 310 may be received for processing by a generative artificial intelligence model to generate a set of tokens including one or more subsets of tokens. In response, the generative artificial intelligence model generates a first subset of tokens including tokens 320, 322, 324, 326, and 328 (assuming, as illustrated, a beam width of k=5, though it should be understood that any desired beam width may be used to set the number of tokens included in each subset of tokens). Because the tokens in the first subset of tokens are axiomatically the tokens with the k highest probabilities in a probability distribution, no tokens need be discarded from the first subset of tokens.

Subsequently, the generative artificial intelligence model can speculatively generate tokens based on the input prompt 310 and each token 320, 322, 324, 326, and 328 in the first subset of tokens. Using a defined branching factor of 5, as illustrated, the generative artificial intelligence model can generate a respective set of provisional tokens 321, 323, 325, 327, 329 for each respective token 320, 322, 324, 326, and 328. A probability distribution p(x) may be established over the tokens included in the sets of provisional tokens 321, 323, 325, 327, and 329, with each token having a log probability of log p(x), x∈X={x₁, . . . , x_{N}}, where X represents a universe of tokens based on which the generative artificial intelligence model generates a draft set of tokens. To identify the top k tokens from the sets of provisional tokens 321, 323, 325, 327, and 329, a Gumbel distribution of independent and identically distributed random variables may be sampled over the universe of tokens X, such that each x∈X has a corresponding Gumbel random noise G∈Gumbel (ϕ), where ϕ corresponds to a cumulative probability distribution over X. The log probability associated with each token may be perturbed by the corresponding Gumbel random noise for the token, such that the value based on which the top k tokens are selected for inclusion in the second subset of tokens equals log p(xₙ)+Gₚ, n∈N over the universe of tokens X.

To identify the top k tokens, the perturbed log probabilities associated with the tokens in the sets of provisional tokens 321, 323, 325, 327, and 329 may be sampled without replacing the tokens. Random variables \hat{X} may be established for the k tokens selected from the sets of provisional tokens 321, 323, 325, 327, and 329, with random variable \hat{X}₁ corresponding to the token with the highest perturbed log probability. Generally, \hat{X}₁ may be represented by the following expression:

$${\hat{X}}_{1} \sim {p}_{1} ( x ) := p ( x ) , x ∈ X$$

That is, the probability distribution associated with the token with the highest perturbed log probability may be an unadjusted probability distribution over the draft set of tokens. Meanwhile, subsequent random variables (e.g., random variables \hat{X}₂ through \hat{X}ₖ) may be generated based on the removal of p₁(x) from the probability distribution. For example, \hat{X}₂ may be represented by the expression:

$${\hat{X}}_{2} \sim {p}_{2} ( x ) := \frac{p ( x )}{1 - {p}_{1} ( {\hat{X}}_{1} )} , x ∈ \frac{X}{{\hat{\{ X}}_{1} \}}$$

More generally, for n∈{2, . . . , k}, \hat{X}ₙ may be represented by the expression:

$${\hat{X}}_{n} \sim {p}_{n} ( x ) := \frac{{p}_{n - 1} ( x )}{1 - {p}_{n - 1} ( {\hat{X}}_{n - 1} )} , x ∈ \frac{X}{\{ {\hat{X}}_{n - 1} \}}$$

As illustrated, the top k tokens from the sets of provisional tokens 321, 323, 325, 327, 329 include three tokens from the set of provisional tokens 321, no tokens from the set of provisional tokens 323, one token from the set of provisional tokens 325, one token from the set of provisional tokens 327, and no tokens from the set of provisional tokens 329. Thus, the second subset of tokens may include tokens 330, 332, and 334 selected from the set of provisional tokens 321, token 336 selected from the set of provisional tokens 325, and token 338 selected from the set of provisional tokens 327.

A similar analysis may be performed based on provisional sets of tokens 331, 333, 335, 337, 339 generated by the draft model based on the tokens 330, 332, 334, 336, and 338, respectively. Based on log probabilities for each token in the provisional sets of tokens 331, 333, 335, 337, 339, perturbed based on Gumbel random noise associated with each token, the third subset of tokens may be selected as the k tokens with the highest perturbed log probabilities. As illustrated, no tokens may be selected for inclusion in the third subset of tokens from the provisional set of tokens 331; two tokens may be selected for inclusion in the third subset of tokens from the provisional set of tokens 333; no tokens may be selected for inclusion in the third subset of tokens from the provisional set of tokens 335; three tokens may be selected for inclusion in the third subset of tokens from the provisional set of tokens 337; and no tokens may be selected for inclusion in the third subset of tokens from the provisional set of tokens 339.

Finally, assuming a draft length L=4, as illustrated in FIG. 3, a fourth subset of tokens may be generated based on the tokens 340, 342, 344, 346, and 348, and provisional sets of tokens 341, 343, 345, 347, and 349. Based on the perturbed log probabilities for the tokens included in the provisional sets of tokens 341, 343, 345, 347, and 349, it may be seen that one token is included in the fourth subset of tokens from each provisional set of tokens 341, 343, 345, 347, and 349.

The techniques described herein may thus be considered a “greedy” technique that results in the generation of a set of tokens representing a draft response to the input query that maintains a constant size across subsets of tokens. In generating the set of tokens, computational resources may not be used to generate children tokens for parent tokens with low probabilities, as these parent tokens are unlikely to be selected for inclusion in a response to the input query and children of these parent tokens are increasingly unlikely to be selected for inclusion. Thus, the number of tokens speculatively generated for each portion of a response (where each subset of tokens discussed above corresponds to a discrete portion of a response) may remain constant despite the depth of each portion of the response in the set of draft tokens, instead of growing exponentially with the depth of each portion of the response in the set of draft tokens.

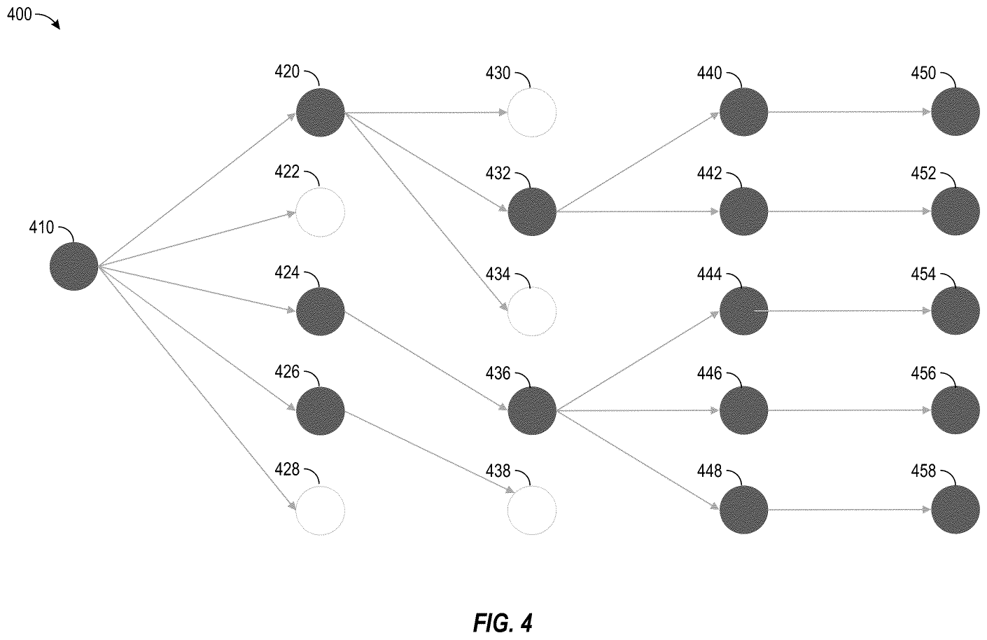

FIG. 4 illustrates a tree 400 of tokens generated using recursive speculative decoding and a constant beam width for a beam search through a set of speculatively generated tokens, according to aspects of the present disclosure.

The tree 400 generally corresponds to the tokens selected for inclusion in each subset of tokens discussed above with respect to FIG. 3. As illustrated, the tree 400 may include a root node 410 corresponding to the input query (or prompt) based on which the remaining nodes, corresponding to different speculatively generated tokens, are generated. As illustrated, each level in the tree data structure, corresponding to different subsets of tokens, includes the same number of tokens. This number of tokens, as discussed, may correspond to a defined beam width for a beam search through the generated set of tokens; however, unlike a breadth-first beam search that starts at a final subset of tokens in a draft set of tokens, the beam search discussed herein and illustrated in FIG. 3 may be performed sequentially from an initial subset of tokens in a draft set of tokens.

Within the tree 400, each continuous path from the root node 410 to a terminal leaf node (also referred to as a “navigable path”) may correspond to a candidate response to the input query represented by the root node 410. Because of the techniques based on which subsets of tokens are generated, different candidate responses may have different lengths. For example, a candidate response to the input query may include a single token as illustrated by nodes 422 and 428. That is, for the nodes 422 and 428, generation of a candidate response may be truncated early based on the absence of children tokens for the nodes 422 and 428 in the top k tokens in the second subset of tokens (as discussed above).

Similarly, three candidate responses in the tree 400 may include two tokens. A first of these candidate responses may include tokens associated with nodes 420 and 430; a second of these candidate responses may include tokens associated with nodes 420 and 434, and a third of these candidate responses may include tokens associated with nodes 426 and 438. In each of these cases, no token speculatively generated based on the terminating tokens in these continuous paths are included in the top k tokens based on which the third subset of tokens (including tokens associated with nodes 440, 442, 444, 446, and 448) is generated. Thus, early truncation of token generation may be performed with respect to the tokens associated with the nodes 430, 434, and 438.

Finally, the remaining candidate responses in the tree 400, as illustrated include a number of tokens corresponding to the maximum length of a draft set of tokens generated by the draft model. A first of these candidate responses may include tokens associated with the nodes 420, 432, 440, and 450; a second of these candidate responses may include tokens associated with the nodes 420, 432, 442, and 452; a third of these candidate responses may include tokens associated with the nodes 424, 436, 444, and 454; a fourth of these candidate responses may include tokens associated with the nodes 424, 436, 446, and 456; and a fifth and final of these candidate responses may include tokens associated with the nodes 424, 436, 448, and 458.

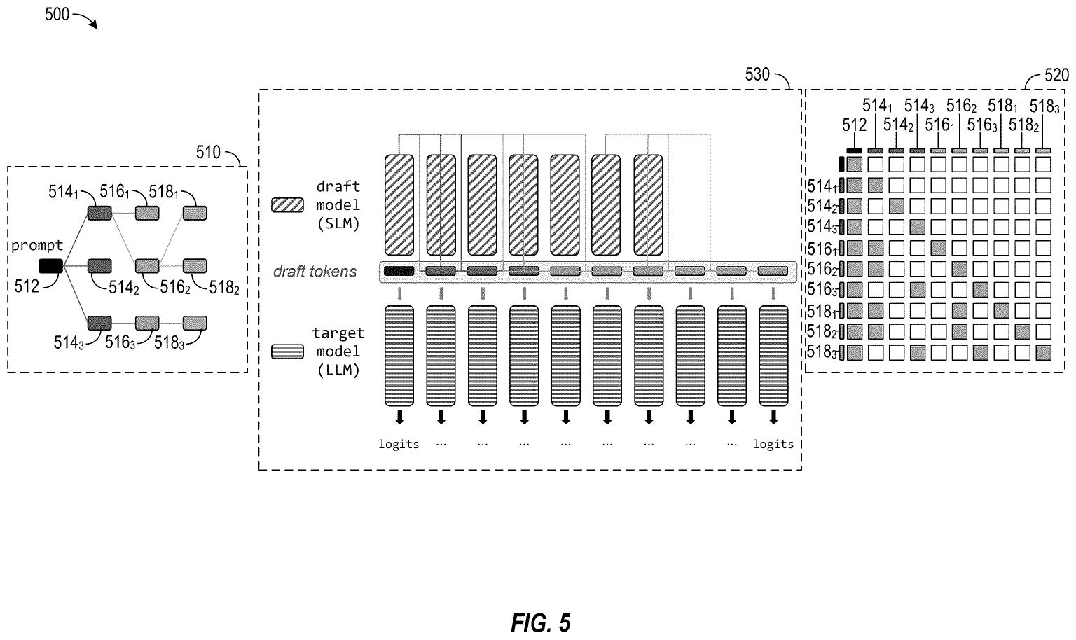

FIG. 5 illustrates an example 500 of recursive speculative decoding in generative artificial intelligence models using a constant beam width for a beam search through a set of speculatively generated tokens and an attention map representing a set of speculatively decoded tokens, according to aspects of the present disclosure.

To allow for a target model to verify the draft set tokens speculatively generated using the techniques discussed above with respect to FIGS. 3 and 4, aspects of the present disclosure may provide for the generation of an attention map 520 corresponding to a set of tokens 510 and the continuous paths therein. The attention map 520 generally illustrates, for each token included in the set of tokens 510, the continuous path of tokens associated with a given token to allow for the accurate execution of the attention mechanism in a transformer block of the target model. As illustrated, the attention map 520 may be a two-dimensional model with dimensions corresponding to the total number of nodes included in the set of tokens 510. Each respective token included in the set of tokens 510 may have a corresponding row and column in the attention map 520 illustrating the continuous path (e.g., intervening tokens) associated with that respective token, with the presence of a particular token in a continuous path represented by a binary value of 1 (illustrated as a shaded box) in the appropriate column in the attention map 520. For example, a root node 512 in the set of tokens 510, corresponding to the input query (or prompt), may be represented in the attention map 520 as having a single node in the path (i.e., the root node 512) as illustrated by the row corresponding to the root node 512. Nodes 5141, 5142, and 5143, corresponding to the first subset of tokens, may be represented in the attention map 520 as having two nodes in the path (i.e., the root node 512 and each respective node 514) in each of the corresponding rows in the attention map 520. For example, for the node 5141, two boxes may be shaded: a first box corresponding to the root node 512 and a second box corresponding to the node 5141, and similar configurations in the attention map 520 may be established for the nodes 5142 and 5143.

Nodes 5161, 5162, and 5163 may be represented by their respective rows in the attention map 520 as having three nodes in each continuous path. However, because none of the nodes 5161, 5162, and 5163 depend from the node 5142, the rows associated with each of the nodes 5161, 5162, and 5163 in the attention map 520 may not show a dependency on the node 5142 (e.g., may have a value of 0 in the column corresponding to the node 5142). Similarly, because none of nodes 5181, 5182, 5183 depend from the node 5161, the rows associated with each of the nodes 5181, 5182, and 5183 in the attention map 520 may not show a dependency on the node 5161 (e.g., may have a value of 0 in the column corresponding to the node 5161).

The resulting set of tokens 510 and the attention map 520 may be processed by a target model according to block 530. In doing so, the draft model may generate the set of tokens 510 and the corresponding attention map 520 and output both the set of tokens 510 and the corresponding attention map 520 to the target model for processing. The target model, meanwhile, can use the attention map 520 to generate attention values for each token in the set of tokens 510 according to the paths illustrated in the attention map and can perform rejection sampling (e.g., as discussed above with respect to FIGS. 2A and 2B) on the tokens in the set of tokens 510. The resulting output of the target model may be an indication of a candidate response to be output as the response to the input query represented by the root node 512. Generally, the candidate response may be at least a subset of any continuous sequence of tokens illustrated in the set of tokens 510 and may include an additional token sampled from a probability distribution after rejection of a final token from any given sequence of tokens. In some aspects, the candidate response may be the response having the longest length, or the response including the largest number of tokens from the set of tokens 510 verified by the target model.

### Example Operations for Efficient Recursive Speculative Decoding Using a Constant Beam Width in Generative Artificial Intelligence Models

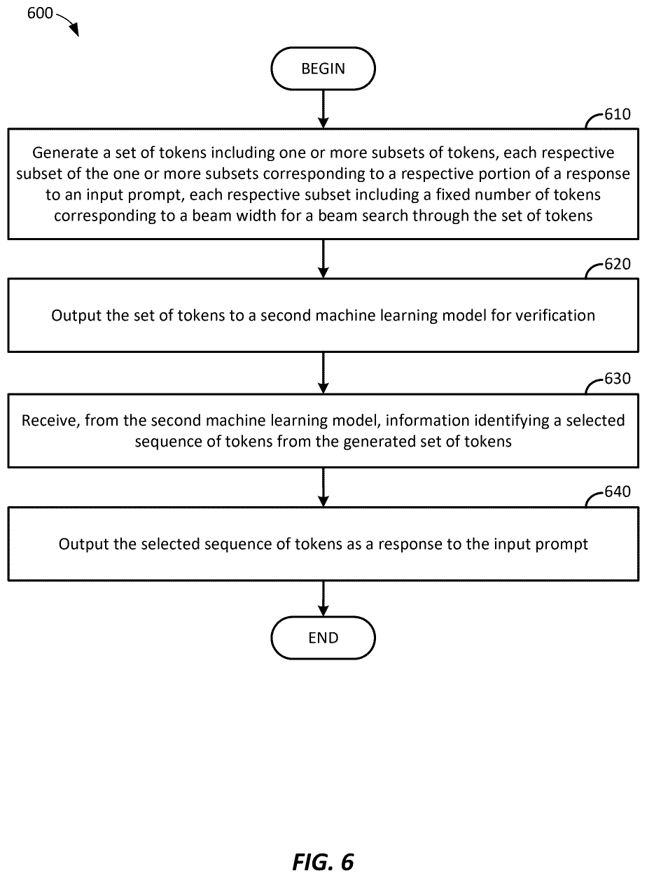

FIG. 6 illustrates example operations 600 that may be performed by a computing device to generate a response to an input prompt using generative artificial intelligence models (e.g., as discussed herein with respect to FIGS. 3 through 5), according to aspects of the present disclosure. The operations 600 may be performed by a computing device on which at least a draft model can be deployed, such as a laptop computer, a desktop computer, a server, a cloud compute instance hosted in a distributed computing environment, or the like.

As illustrated, the operations 600 begin at block 610, with generating, based on an input prompt and using a first machine learning model (e.g., a draft model), a set of tokens including one or more subsets of tokens. Generally, each respective subset of the one or more subsets may correspond to a respective portion of a response to the input prompt. Each respective subset may include a fixed number of tokens corresponding to a beam width for a beam search through the set of tokens.

In some aspects, generating the set of tokens includes generating a first subset of tokens corresponding to a first portion of the response to the input prompt based on the input prompt and using the first machine learning model. Based on the input prompt and the first subset of tokens, and using the first machine learning model, a second subset of tokens may be speculatively generated. The second subset of tokens may correspond to a second portion of the response to the input prompt.

In some aspects, speculatively generating the second subset of tokens includes speculatively generating a draft set of tokens including a respective group of tokens for each respective token in the first subset of tokens. A top group of tokens may be selected. This top group of tokens generally includes the number of tokens having highest probabilities from the draft set of tokens.

In some aspects, probabilities associated with each token in the draft set of tokens comprise a log probability perturbed based on Gumbel random noise.

In some aspects, a probability distribution associated with a first token in the top group of tokens comprises an unadjusted probability distribution over the draft set of tokens. A probability distribution associated with a second token in the top group of tokens comprises a probability distribution over the draft set of tokens adjusted based on the probability distribution associated with the first token in the top group of tokens.

At block 620, the operations 600 proceed with outputting the set of tokens to a second machine learning model (e.g., a target model) for verification.

At block 630, the operations 600 proceed with receiving, from the second machine learning model, information identifying a selected sequence of tokens from the generated set of tokens.

At block 640, the operations 600 proceed with outputting the selected sequence of tokens as a response to the input prompt.

In some aspects, the set of tokens comprises a tree data structure including a root node corresponding to the input prompt and one or more levels associated with the one or more subsets of tokens. Each respective subset of the one or more subsets of tokens may correspond to a respective level in the tree data structure. Each level in the tree data structure may have a width equal to the fixed number of tokens.

In some aspects, the operations 600 further include generating an attention map based on the tree data structure, the attention map identifying sequences of tokens in the tree data structure. The attention map may be output to the second machine learning model for the second machine learning model to use in verifying the sequence of tokens.

In some aspects, the first machine learning model and the second machine learning model comprise a same generative artificial intelligence model. The second machine learning model may be configured to generate the selected sequence of tokens based on maximizing a number of tokens included in the selected sequence of tokens.

In some aspects, a number of the one or more subsets of tokens corresponds to a maximum number of tokens generated by a single pass through the first machine learning model.

In some aspects, the first machine learning model may correspond to a draft model in a speculative decoding pipeline. The second machine learning model may correspond to a target model in the speculative decoding pipeline.

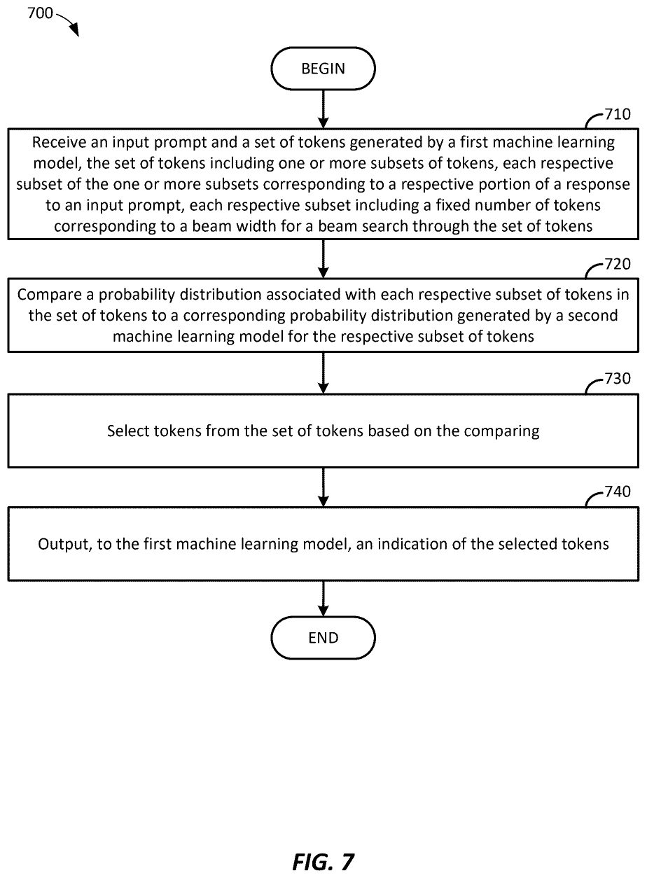

FIG. 7 illustrates example operations 700 that may be performed by a computing device to verify a response to an input prompt using generative artificial intelligence models (e.g., as discussed herein with respect to FIGS. 3 through 5), according to aspects of the present disclosure. The operations 700 may be performed by a computing device on which at least a target model can be deployed, such as a laptop computer, a desktop computer, a server, a cloud compute instance hosted in a distributed computing environment, or the like.

As illustrated, the operations 700 begin at block 710, with receiving an input prompt and a set of tokens generated by a first machine learning model. Generally, the set of tokens includes one or more subsets of tokens. Each respective subset of the one or more subsets generally corresponds to a respective portion of a response to the input prompt and includes a fixed number of tokens corresponding to a defined beam width for a beam search through the set of tokens.

At block 720, the operations 700 proceed with comparing a probability distribution associated with each respective subset of tokens in the set of tokens to a corresponding probability distribution generated by a second machine learning model for the respective subset of tokens.

At block 730, the operations 700 proceed with selecting tokens from the set of tokens based on the comparing.

In some aspects, selecting the tokens from the set of tokens based on the comparing comprise selecting a sequence of tokens from the set of tokens based on maximizing a number of tokens included in the selected sequence of tokens.

In some aspects, selecting the tokens from the set of tokens may include selecting the tokens based on recursive adjustment of a target distribution associated with the set of tokens. Generally, the recursive adjustment of the target distribution includes determining whether to accept or reject a first token in a subset of tokens from the set of tokens and adjusting a probability distribution used to verify a second token in the set of tokens subsequent to the first token based on the determination of whether to accept or reject the first token. In some aspects, adjusting the probability distribution may include subtracting a probability value associated with the first token from the probability distribution based on determining to reject the first token.

In some aspects, selecting the tokens from the set of tokens includes rejecting a first token at a first level of a tree data structure representing the set of tokens. An adjusted probability distribution is generated based on the rejection of the first token. Children tokens of the first token at levels deeper than the first level of the tree data structure are discarded or ignored from the tree data structure. It is determined whether to accept or reject a second token at the first level of the tree data structure based on the adjusted probability distribution.

In some aspects, selecting the tokens from the set of tokens includes rejecting each subset of tokens generated by the first machine learning model. Using the second machine learning model, a token is sampled based on a target distribution that excludes probabilities associated with each subset of tokens generated by the first machine learning model, wherein the selected tokens comprise the sampled token.

At block 740, the operations 700 proceed with outputting, to the first machine learning model, an indication of the selected tokens.

In some aspects, the set of tokens comprises a tree data structure including a root node corresponding to the input prompt and one or more levels associated with the one or more subsets of tokens. Each respective subset of the one or more subsets of tokens may correspond to a respective level in the tree data structure. Each level in the tree data structure may have a width equal to the fixed number of tokens. In some aspects, the operations 700 may further include receiving an attention map based on the tree data structure, the attention map identifying sequences of tokens in the tree data structure. The comparing may be based at least in part on the attention map.

### Example Processing Systems for Efficient Recursive Speculative Decoding in Generative Artificial Intelligence Models

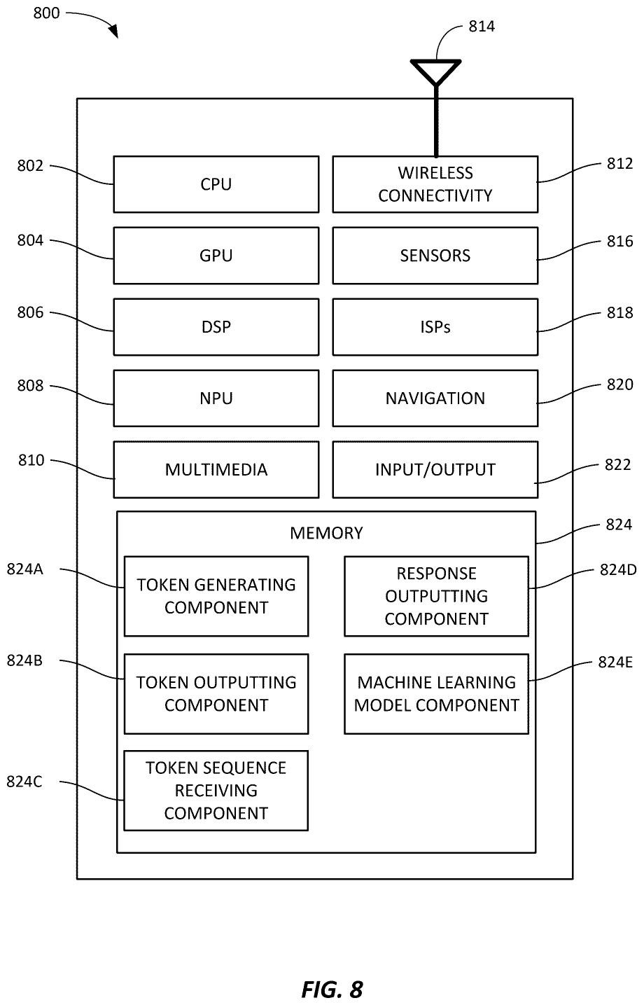

FIG. 8 depicts an example processing system 800 for efficiently generating a response to a query input into a generative artificial intelligence model based on efficient recursive speculative decoding, such as described herein, for example, with respect to FIG. 6.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., of a memory 824).

The processing system 800 also includes additional processing components tailored to specific functions, such as a graphics processing unit (GPU) 804, a digital signal processor (DSP) 806, a neural processing unit (NPU) 808, and a connectivity component 812.

An NPU, such as the NPU 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples, such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 808 is a part of one or more of the CPU 802, the GPU 804, and/or the DSP 806. These may be located on a user equipment (UE) in a wireless communication system or another computing device.

In some examples, the connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 812 may be further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes the memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a token generating component 824A, a token outputting component 824B, a token sequence receiving component 824C, a response outputting component 824D, and a machine learning model component 824E. The depicted components, and others not depicted, may be configured to perform various aspects of the methods described herein.

Generally, the processing system 800 and/or components thereof may be configured to perform the methods described herein.

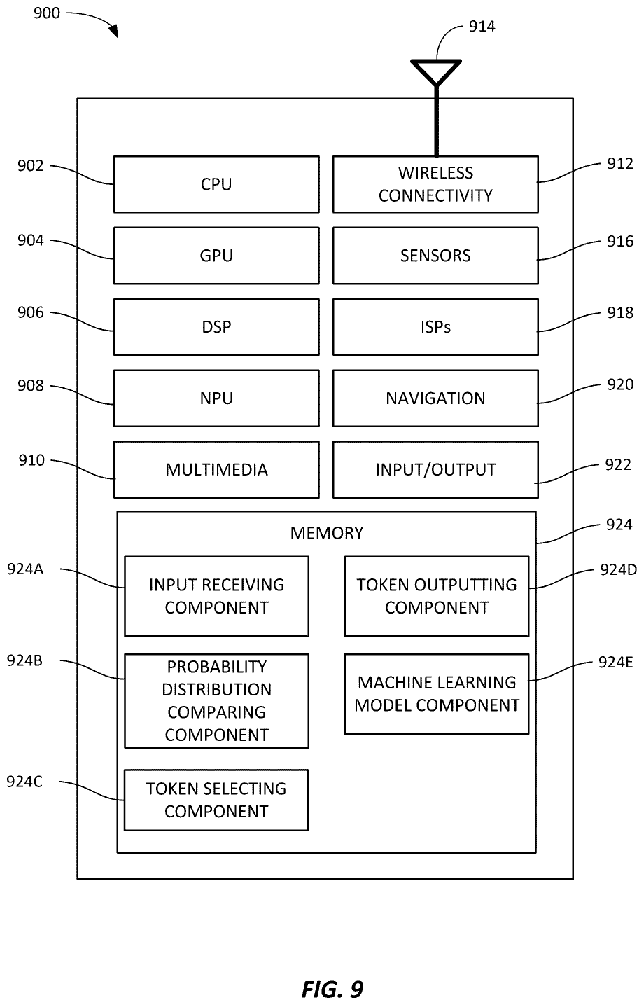

FIG. 9 depicts an example processing system 900 for generating a response to a query input into a generative artificial intelligence model based on efficient recursive speculative decoding, such as described herein for example with respect to FIG. 7.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., of a memory 924).

The processing system 900 also includes additional processing components tailored to specific functions, such as a graphics processing unit (GPU) 904, a digital signal processor (DSP) 906, a neural processing unit (NPU) 908, and a connectivity component 912.

An NPU, such as the NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 908 is a part of one or more of the CPU 902, the GPU 904, and/or the DSP 906. These may be located on a user equipment (UE) in a wireless communication system or another computing device.

In some examples, the connectivity component 912 may include subcomponents, for example, for third generation (3G) connectivity, fourth generation (4G) connectivity (e.g., LTE), fifth generation (5G) connectivity (e.g., NR), Wi-Fi connectivity, Bluetooth connectivity, and other wireless data transmission standards. The connectivity component 912 may be further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes the memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes an input receiving component 924A, a probability distribution comparing component 924B, a token selecting component 924C, a token outputting component 924D, and a machine learning model component 924E. The depicted components, and others not depicted, may be configured to perform various aspects of the methods described herein.

Generally, the processing system 900 and/or components thereof may be configured to perform the methods described herein.

### Example Clauses

Implementation details of various aspects of the present disclosure are described in the following numbered clauses.

Clause 1: A processor-implemented method, comprising: generating, based on an input prompt and using a first machine learning model, a set of tokens including one or more subsets of tokens, each respective subset of the one or more subsets corresponding to a respective portion of a response to the input prompt, each respective subset including a fixed number of tokens corresponding to a beam width for a beam search through the set of tokens; outputting the set of tokens to a second machine learning model for verification; receiving, from the second machine learning model, information identifying a selected sequence of tokens from the generated set of tokens; and outputting the selected sequence of tokens as a response to the input prompt.

Clause 2: The method of Clause 1, wherein generating the set of tokens comprises: generating a first subset of tokens corresponding to a first portion of the response to the input prompt based on the input prompt and using the first machine learning model; and speculatively generating, based on the input prompt and the first subset of tokens and using the first machine learning model, a second subset of tokens corresponding to a second portion of the response to the input prompt.

Clause 3: The method of Clause 2, wherein speculatively generating the second subset of tokens comprises: speculatively generating a draft set of tokens including a respective group of tokens for each respective token in the first subset of tokens; and selecting a top group of tokens including the number of tokens having highest probabilities from the draft set of tokens.

Clause 4: The method of Clause 3, wherein probabilities associated with each token in the draft set of tokens comprise a log probability perturbed based on Gumbel random noise.

Clause 5: The method of Clause 3 or 4, wherein: a probability distribution associated with a first token in the top group of tokens comprises an unadjusted probability distribution over the draft set of tokens, and a probability distribution associated with a second token in the top group of tokens comprises a probability distribution over the draft set of tokens adjusted based on the probability distribution associated with the first token in the top group of tokens.

Clause 6: The method of any of Clauses 1 through 5, wherein: the set of tokens comprises a tree data structure including a root node corresponding to the input prompt and one or more levels associated with the one or more subsets of tokens, each respective subset of the one or more subsets of tokens corresponds to a respective level in the tree data structure, and each level in the tree data structure has a width equal to the fixed number of tokens.

Clause 7: The method of Clause 6, further comprising: generating an attention map based on the tree data structure, the attention map identifying sequences of tokens in the tree data structure; and outputting the attention map to the second machine learning model for the second machine learning model to use in verifying the sequence of tokens.

Clause 8: The method of any of Clauses 1 through 7, wherein the first machine learning model and the second machine learning model comprise a same generative artificial intelligence model.

Clause 9: The method of Clause 8, wherein the second machine learning model is configured to generate the selected sequence of tokens based on maximizing a number of tokens included in the selected sequence of tokens.

Clause 10: The method of any of Clauses 1 through 9, wherein a number of the one or more subsets of tokens corresponds to a maximum number of tokens generated by a single pass through the first machine learning model.

Clause 11: The method of any of Clauses 1 through 10, wherein: the first machine learning model corresponds to a draft model in a speculative decoding pipeline; and the second machine learning model corresponds to a target model in the speculative decoding pipeline.

Clause 12: A processor-implemented method, comprising: receiving an input prompt and a set of tokens generated by a first machine learning model, the set of tokens including one or more subsets of tokens, each respective subset of the one or more subsets corresponding to a respective portion of a response to the input prompt, each subset including a fixed number of tokens corresponding to a defined beam width for a beam search through the set of tokens; comparing a probability distribution associated with each respective subset of tokens in the set of tokens to a corresponding probability distribution generated by a second machine learning model for the respective subset of tokens; selecting tokens from the set of tokens based on the comparing; and outputting, to the first machine learning model, an indication of the selected tokens.

Clause 13: The method of Clause 12, wherein: the set of tokens comprises a tree data structure including a root node corresponding to the input prompt and one or more levels associated with the one or more subsets of tokens, each respective subset of the one or more subsets of tokens corresponds to a respective level in the tree data structure, and each level in the tree data structure has a width equal to the fixed number of tokens.

Clause 14: The method of Clause 13, further comprising receiving an attention map based on the tree data structure, the attention map identifying sequences of tokens in the tree data structure, wherein the comparing is based at least in part on the attention map.

Clause 15: The method of any of Clauses 12 through 14, wherein selecting the tokens from the set of tokens based on the comparing comprise selecting a sequence of tokens from the set of tokens based on maximizing a number of tokens included in the selected sequence of tokens.

Clause 16: The method of any of Clauses 12 through 15, wherein the selecting the tokens from the set of tokens comprises selecting the tokens based on recursive adjustment of a target distribution associated with the set of tokens.

Clause 17: The method of Clause 16, wherein the recursive adjustment of the target distribution comprises: determining whether to accept or reject a first token in a subset of tokens from the set of tokens; and adjusting a probability distribution used to verify a second token in the set of tokens subsequent to the first token based on the determination of whether to accept or reject the first token.

Clause 18: The method of Clause 17, wherein adjusting the probability distribution comprises subtracting a probability value associated with the first token from the probability distribution based on determining to reject the first token.

Clause 19: The method of any of Clauses 12 through 18, wherein selecting the tokens from the set of tokens comprises: rejecting a first token at a first level of a tree data structure representing the set of tokens; generating an adjusted probability distribution based on the rejection of the first token; discarding or ignoring, from the tree data structure, children tokens of the first token at levels deeper than the first level of the tree data structure; and determining whether to accept or reject a second token at the first level of the tree data structure based on the adjusted probability distribution.

Clause 20: The method of any of Clauses 12 through 19, wherein selecting the tokens from the set of tokens comprises: rejecting each subset of tokens generated by the first machine learning model; and sampling, using the second machine learning model, a token based on a target distribution that excludes probabilities associated with each subset of tokens generated by the first machine learning model, wherein the selected tokens comprise the sampled token.

Clause 21: A processing system, comprising: at least one memory having executable instructions stored thereon; and one or more processors configured to execute the executable instructions in order to cause the processing system to perform the operations of any of Clauses 1 through 20.

Clause 22: A processing system comprising means for performing the operations of any of Clauses 1 through 20.

Clause 23: A non-transitory computer-readable medium having executable instructions stored thereon which, when executed by one or more processors, perform the operations of any of Clauses 1 through 20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions to cause the processing system to:
generate, based on an input prompt and using a first machine learning model, a set of tokens including one or more subsets of tokens, each respective subset of the one or more subsets corresponding to a respective portion of a response to the input prompt, each respective subset including a fixed number of tokens corresponding to a beam width for a beam search through the set of tokens;
output the set of tokens to a second machine learning model for verification;
receive, from the second machine learning model, information identifying a selected sequence of tokens from the generated set of tokens; and
output the selected sequence of tokens as the response to the input prompt.

2. The processing system of claim 1, wherein to generate the set of tokens, the one or more processors are configured to cause the processing system to:
generate a first subset of tokens corresponding to a first portion of the response to the input prompt based on the input prompt and using the first machine learning model; and
speculatively generate, based on the input prompt and the first subset of tokens and using the first machine learning model, a second subset of tokens corresponding to a second portion of the response to the input prompt.

3. The processing system of claim 2, wherein to speculatively generate the second subset of tokens, the one or more processors are configured to cause the processing system to:
speculatively generate a draft set of tokens including a respective group of tokens for each respective token in the first subset of tokens; and
select a top group of tokens including a number of tokens having highest probabilities from the draft set of tokens.

4. The processing system of claim 3, wherein probabilities associated with each token in the draft set of tokens comprise a log probability perturbed based on Gumbel random noise.

5. The processing system of claim 3, wherein:
a probability distribution associated with a first token in the top group of tokens comprises an unadjusted probability distribution over the draft set of tokens, and
a probability distribution associated with a second token in the top group of tokens comprises a probability distribution over the draft set of tokens adjusted based on the probability distribution associated with the first token in the top group of tokens.

6. The processing system of claim 1, wherein:
the set of tokens comprises a tree data structure including a root node corresponding to the input prompt and one or more levels associated with the one or more subsets of tokens,
each respective subset of the one or more subsets of tokens corresponds to a respective level in the tree data structure, and
each level in the tree data structure has a width equal to the fixed number of tokens.

7. The processing system of claim 6, wherein the one or more processors are further configured to cause the processing system to:
generate an attention map based on the tree data structure, the attention map being configured to identify sequences of tokens in the tree data structure; and
output the attention map to the second machine learning model for the second machine learning model to use in verifying the sequence of tokens.

8. The processing system of claim 1, wherein the first machine learning model and the second machine learning model comprise a same generative artificial intelligence model.

9. The processing system of claim 8, wherein the second machine learning model is configured to generate the selected sequence of tokens based on maximizing a number of tokens included in the selected sequence of tokens.

10. The processing system of claim 1, wherein a number of the one or more subsets of tokens corresponds to a maximum number of tokens generated by a single pass through the first machine learning model.

11. The processing system of claim 1, wherein:
the first machine learning model corresponds to a draft model in a speculative decoding pipeline; and
the second machine learning model corresponds to a target model in the speculative decoding pipeline.

12. A processing system, comprising:
at least one memory having executable instructions stored thereon; and
one or more processors configured to execute the executable instructions to cause the processing system to:
receive an input prompt and a set of tokens generated by a first machine learning model, the set of tokens including one or more subsets of tokens, each respective subset of the one or more subsets corresponding to a respective portion of a response to the input prompt, each subset including a fixed number of tokens corresponding to a defined beam width for a beam search through the set of tokens;
compare a probability distribution associated with each respective subset of tokens in the set of tokens to a corresponding probability distribution generated by a second machine learning model for the respective subset of tokens;
select tokens from the set of tokens based on the comparing; and
output, to the first machine learning model, an indication of the selected tokens.

13. The processing system of claim 12, wherein:
the set of tokens comprises a tree data structure including a root node corresponding to the input prompt and one or more levels associated with the one or more subsets of tokens,
each respective subset of the one or more subsets of tokens corresponds to a respective level in the tree data structure, and
each level in the tree data structure has a width equal to the fixed number of tokens.

14. The processing system of claim 13, wherein:
the one or more processors are further configured to cause the processing system to receive an attention map based on the tree data structure;
the attention map is configured to identify sequences of tokens in the tree data structure; and
the one or more processors are configured to compare the probability distribution associated with each respective subset of tokens in the set of tokens to the corresponding probability distribution generated by the second machine learning model for the respective subset of tokens based at least in part on the attention map.

15. The processing system of claim 12, wherein to select the tokens from the set of tokens based on the comparing, the one or more processors are configured to cause the processing system to select a sequence of tokens from the set of tokens based on maximizing a number of tokens included in the selected sequence of tokens.

16. The processing system of claim 12, wherein to select the tokens from the set of tokens, the one or more processors are configured to cause the processing system to select the tokens based on recursive adjustment of a target distribution associated with the set of tokens.

17. The processing system of claim 16, wherein to recursively adjust the target distribution, the one or more processors are configured to cause the processing system to:
determine whether to accept or reject a first token in a subset of tokens from the set of tokens; and
adjust a probability distribution used to verify a second token in the set of tokens subsequent to the first token based on the determination of whether to accept or reject the first token.

18. The processing system of claim 17, wherein to adjust the probability distribution, the one or more processors are configured to cause the processing system to subtract a probability value associated with the first token from the probability distribution based on determining to reject the first token.

19. The processing system of claim 12, wherein to select the tokens from the set of tokens, the one or more processors are configured to cause the processing system to:
reject a first token at a first level of a tree data structure representing the set of tokens;
generate an adjusted probability distribution based on the rejection of the first token;
discard or ignore, from the tree data structure, children tokens of the first token at levels deeper than the first level of the tree data structure; and
determine whether to accept or reject a second token at the first level of the tree data structure based on the adjusted probability distribution.

20. The processing system of claim 12, wherein to select the tokens from the set of tokens, the one or more processors are configured to cause the processing system to:
reject each subset of tokens generated by the first machine learning model; and
sample, using the second machine learning model, a token based on a target distribution that excludes probabilities associated with each subset of tokens generated by the first machine learning model, wherein the selected tokens comprise the sampled token.

21. A processor-implemented method, comprising:
generating, based on an input prompt and using a first machine learning model, a set of tokens including one or more subsets of tokens, each respective subset of the one or more subsets corresponding to a respective portion of a response to the input prompt, each respective subset including a fixed number of tokens corresponding to a beam width for a beam search through the set of tokens;
outputting the set of tokens to a second machine learning model for verification;
receiving, from the second machine learning model, information identifying a selected sequence of tokens from the generated set of tokens; and
outputting the selected sequence of tokens as the response to the input prompt.

22. The method of claim 21, wherein generating the set of tokens comprises:
generating a first subset of tokens corresponding to a first portion of the response to the input prompt based on the input prompt and using the first machine learning model; and
speculatively generating, based on the input prompt and the first subset of tokens and using the first machine learning model, a second subset of tokens corresponding to a second portion of the response to the input prompt.

23. The method of claim 22, wherein speculatively generating the second subset of tokens comprises:
speculatively generating a draft set of tokens including a respective group of tokens for each respective token in the first subset of tokens; and
selecting a top group of tokens including a number of tokens having highest probabilities from the draft set of tokens.

24. The method of claim 23, wherein probabilities associated with each token in the draft set of tokens comprise a log probability perturbed based on Gumbel random noise.

25. The method of claim 23, wherein:
a probability distribution associated with a first token in the top group of tokens comprises an unadjusted probability distribution over the draft set of tokens, and
a probability distribution associated with a second token in the top group of tokens comprises a probability distribution over the draft set of tokens adjusted based on the probability distribution associated with the first token in the top group of tokens.

26. The method of claim 21, wherein:
the set of tokens comprises a tree data structure including a root node corresponding to the input prompt and one or more levels associated with the one or more subsets of tokens,
each respective subset of the one or more subsets of tokens corresponds to a respective level in the tree data structure, and
each level in the tree data structure has a width equal to the fixed number of tokens.

27. The method of claim 26, further comprising:
generating an attention map based on the tree data structure, the attention map identifying sequences of tokens in the tree data structure; and
outputting the attention map to the second machine learning model for the second machine learning model to use in verifying the sequence of tokens.

28. The method of claim 21, wherein the first machine learning model and the second machine learning model comprise a same generative artificial intelligence model.

29. The method of claim 28, wherein the second machine learning model is configured to generate the selected sequence of tokens based on maximizing a number of tokens included in the selected sequence of tokens.

30. The method of claim 21, wherein a number of the one or more subsets of tokens corresponds to a maximum number of tokens generated by a single pass through the first machine learning model.

31. The method of claim 21, wherein:
the first machine learning model corresponds to a draft model in a speculative decoding pipeline; and
the second machine learning model corresponds to a target model in the speculative decoding pipeline.

32. A processor-implemented method, comprising:
receiving an input prompt and a set of tokens generated by a first machine learning model, the set of tokens including one or more subsets of tokens, each respective subset of the one or more subsets corresponding to a respective portion of a response to the input prompt, and each subset including a fixed number of tokens corresponding to a defined beam width for a beam search through the set of tokens;
comparing a probability distribution associated with each respective subset of tokens in the set of tokens to a corresponding probability distribution generated by a second machine learning model for the respective subset of tokens;
selecting tokens from the set of tokens based on the comparing; and
outputting, to the first machine learning model, an indication of the selected tokens.

33. The method of claim 32, wherein:
the set of tokens comprises a tree data structure including a root node corresponding to the input prompt and one or more levels associated with the one or more subsets of tokens,
each respective subset of the one or more subsets of tokens corresponds to a respective level in the tree data structure, and
each level in the tree data structure has a width equal to the fixed number of tokens.

34. The method of claim 33, further comprising receiving an attention map based on the tree data structure, the attention map identifying sequences of tokens in the tree data structure, wherein the comparing is based at least in part on the attention map.

35. The method of claim 32, wherein selecting the tokens from the set of tokens based on the comparing comprise selecting a sequence of tokens from the set of tokens based on maximizing a number of tokens included in the selected sequence of tokens.

36. The method of claim 32, wherein the selecting the tokens from the set of tokens comprises selecting the tokens based on recursive adjustment of a target distribution associated with the set of tokens.

37. The method of claim 36, wherein the recursive adjustment of the target distribution comprises:
determining whether to accept or reject a first token in a subset of tokens from the set of tokens; and
adjusting a probability distribution used to verify a second token in the set of tokens subsequent to the first token based on the determination of whether to accept or reject the first token.

38. The method of claim 37, wherein adjusting the probability distribution comprises subtracting a probability value associated with the first token from the probability distribution based on determining to reject the first token.

39. The method of claim 32, wherein selecting the tokens from the set of tokens comprises:
rejecting a first token at a first level of a tree data structure representing the set of tokens;
generating an adjusted probability distribution based on the rejection of the first token;
discarding or ignoring, from the tree data structure, children tokens of the first token at levels deeper than the first level of the tree data structure; and
determining whether to accept or reject a second token at the first level of the tree data structure based on the adjusted probability distribution.

40. The method of claim 32, wherein selecting the tokens from the set of tokens comprises:
rejecting each subset of tokens generated by the first machine learning model; and
sampling, using the second machine learning model, a token based on a target distribution that excludes probabilities associated with each subset of tokens generated by the first machine learning model, wherein the selected tokens comprise the sampled token.
